(19) United States
(12) Patent Application Publication
(10) Pub. No.: US 2026/0093457 A1
(43) Pub. Date: Apr. 2, 2026

(54) APPLICATION TEMPLATE GENERATION

(71) Applicant: Freshworks Inc., San Mateo, CA (US)

(72) Inventors: Karthikeyan P. RAMASAMY, Bengaluru (IN); Nithin NAYAGAM, Bengaluru (IN); Aadarsh RENGARAJAN, Chennai (IN); Santhosh BALUSAMY, Chennai (IN); Abhishek KULKARNI, Bengaluru (IN)

(73) Assignee: Freshworks Inc., San Mateo, CA (US)

(21) Appl. No.: 18/904,800

(22) Filed: Oct. 2, 2024

(51) Int. Cl. G06F 8/10; G06F 8/20

(52) U.S. Cl. CPC G06F 8/10; G06F 8/20

(57) ABSTRACT

A method for generating an application template includes receiving a use case from a user, and analyzing the use case for missing attributes or ambiguities. The method also includes communicating with the user with a request, wherein the request is a notification for the user to provide the missing attributes or ambiguities, and receiving a response from the user. The method further includes generating an application template with code across a plurality of files, application manifest, and generated meta data. The application template provides the user closer to a working application.

### FIELD

The present invention generally relates to application template generation, and more specifically, to generating an application template based on a customer use case and design.

### BACKGROUND

The need for an automated app template generation arises from the increasing demand for efficient and user-friendly applications for various customer-provided business use cases. Freshworks™ marketplace and developer platform offer abilities for customers and external developers to build apps. However, there is a learning curve involved for them to understand and learn the Freshworks™ app syntax and structure needed for the building blocks to be coded. This idea solves the time to market and also helps developers to build an app in the Freshworks™ recommended model with a fewer iterations. The automated process of ready to execute level of app template, simplifies the development cycle by generating back end and UI code based on the given use case. This process ultimately helps to fast track the development process. By providing a pre-built template, beginner developers can easily understand the required components and focus on customizing the app to meet the unique needs of their clients.

There are various methods of code generation, which are offered using heuristics and generational AI specific techniques. However, these methods do not offer a complete multi-file aware app template, where the generated content/context of one file is made aware in the another. This file content/context aware model of app template generation makes the process unique and also more efficient for the developer who is using this generated app template.

Accordingly, an improved and/or alternative approach to identity and access management for such technologies may be beneficial.

### SUMMARY

Certain embodiments of the present invention may provide solutions to the problems and needs in the art that have not yet been fully identified, appreciated, or solved by current AI technologies and/or provide a useful alternative thereto. For example, some embodiments of the present invention pertain to generating an application template based on a customer use case and design.

In an embodiment, one or more non-transitory computer-readable media storing one or more computer programs for generating an application template. The one or more computer programs configured to cause at least one processor to perform receiving a use case from a user, and analyzing the use case for missing attributes or ambiguities. The one or more computer programs are further configured to cause at least one processor to communicating with the user with a request, wherein the request is a notification for the user to provide the missing attributes or ambiguities, and receiving a response from the user. The method further includes generating an application template with code across a plurality of files, application manifest, and generated meta data. The application template provides the user closer to a working application.

In another embodiment, method for generating an application template includes receiving a use case from a user, and analyzing the use case for missing attributes or ambiguities. The method also includes communicating with the user with a request, wherein the request is a notification for the user to provide the missing attributes or ambiguities, and receiving a response from the user. The method further includes generating an application template with code across a plurality of files, application manifest, and generated meta data. The application template provides the user closer to a working application.

### BRIEF DESCRIPTION OF THE DRAWINGS

In order that the advantages of certain embodiments of the invention will be readily understood, a more particular description of the invention briefly described above will be rendered by reference to specific embodiments that are illustrated in the appended drawings. While it should be understood that these drawings depict only typical embodiments of the invention and are not therefore to be considered to be limiting of its scope, the invention will be described and explained with additional specificity and detail through the use of the accompanying drawings, in which:

FIG. 1 is a block diagram illustrating a system for generating an application template based on a customer use case, according to an embodiment of the present invention.

FIG. 2 is a diagram illustrating a method for generating an application template, according to an embodiment of the present invention.

FIG. 3 is a diagram illustrating a method for creating or generating the application template, according to an embodiment of the present invention.

FIG. 4 is a flow diagram illustrating a method for performing prompt confirmation when receiving a use case from the user, according to an embodiment of the present invention.

FIG. 5 is a flow diagram illustrating a method for executing an application design process, according to an embodiment of the present invention.

FIG. 6 is a flow diagram illustrating a method for generating an application template based on a customer use case and design, according to an embodiment of the present invention.

FIG. 7 is an architectural diagram illustrating a computing system configured to generate and construction an application template including the components of the application template, according to an embodiment of the present invention.

FIG. 8A illustrates an example of a neural network that has been trained to determine that a query may pertain to a dual-use application, according to an embodiment of the present invention.

FIG. 8B illustrates an example of a neuron, according to an embodiment of the present invention.

FIG. 9 is a flowchart illustrating a process for training AI/ML model(s), according to an embodiment of the present invention.

Unless otherwise indicated, similar reference characters denote corresponding features consistently throughout the attached drawings.

### DETAILED DESCRIPTION OF THE EMBODIMENTS

Some embodiments pertain to generating an application template based on a customer use case and design. Specifically, some embodiments pertain to an automated application template creation system (hereinafter the “system”) to enable one or more or a group users to build applications with respect to the Freshworks™ ecosystem. The Freshworks™ ecosystem includes a plurality of libraries and syntax. In one example, any user external to Freshworks™ that would like to build an application would have to spend hours/weeks/months on how to build an application. In other words, it may be time consuming for an external user to build an application.

To simplify development for external users, the system is configured to capture a use case for which the user is building the application for. Internally, the system executes a number of steps to understand the user's requirements, and then assists in creating the application (as a template) to fast track the use case into an application. For instance, the system may accept customer requirements in the form of a business use case as input. The system then intelligently converts the use case into a ready-to-execute app template for app developers. Utilizing a combination of multiple steps and processing of the provided input with context, the system automatically detects the type of app based on a provided use case, efficiently determining the associated domain and the Freshworks™ product associated with it. The system also identifies the necessary components, such as user interface (UI) web elements or backend event listener capabilities that need to be coded, declared at the application manifest/meta data level.

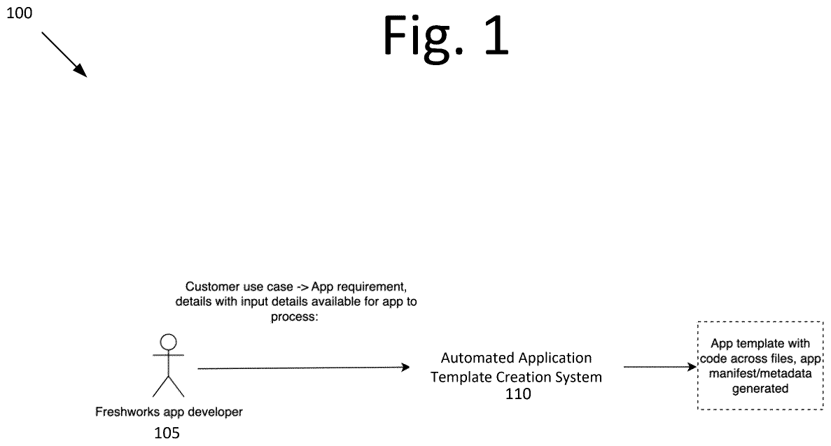

FIG. 1 is a block diagram illustrating a system 100 for generating an application template based on a customer use case, according to an embodiment of the present invention. In some embodiments, a user (or an application developer) 105 may provide a customer use case (hereinafter “use case”) to an automated application template creation system 110. The use case may include application requirements and element details for the application. Automated application template creation system 110 may use the use case to generate an application template, and may output the application template with code across files. In some embodiments, the application template may include an application manifest and metadata.

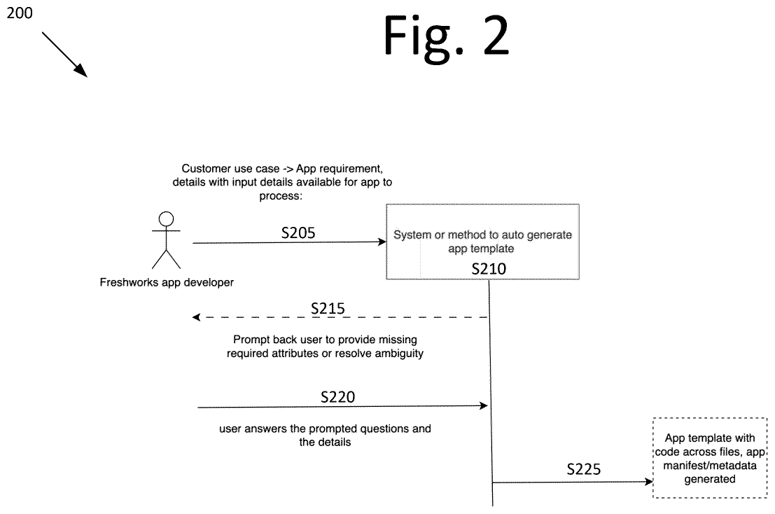

It should be noted that, in some instances, the user provided input does not meet the app requirements score/attributes, resulting in missing attributes. In these instances, the system may prompt the user to provide the missing attributes or attributes with ambiguity before generating the app template. See, for example, FIG. 2.

FIG. 2 is a diagram illustrating a method 200 for generating an application template, according to an embodiment of the present invention. In some embodiment, method 200 may begin at S205 with the system receiving a use case from a user (i.e., application developer). At S210, the system analyzes the use case for missing attributes or for ambiguities. Attributes may include details on the product or business for which the application template is being generated and more details on the third party integration to be achieved, business domain use case, design inputs of the application appearing as a side panel or full page application, etc. At S215, the system may communicate with (or sends a message to) the user with a request. In the request, the user is requested to provide the missing attributes or for the user to resolve the ambiguity found in the use case. At S220, the system receives the answers to the questions, including requested details, from the user. At S225, the system generates the application template with code across files, application manifest and generated metadata. This application template may take the user closer to a working application.

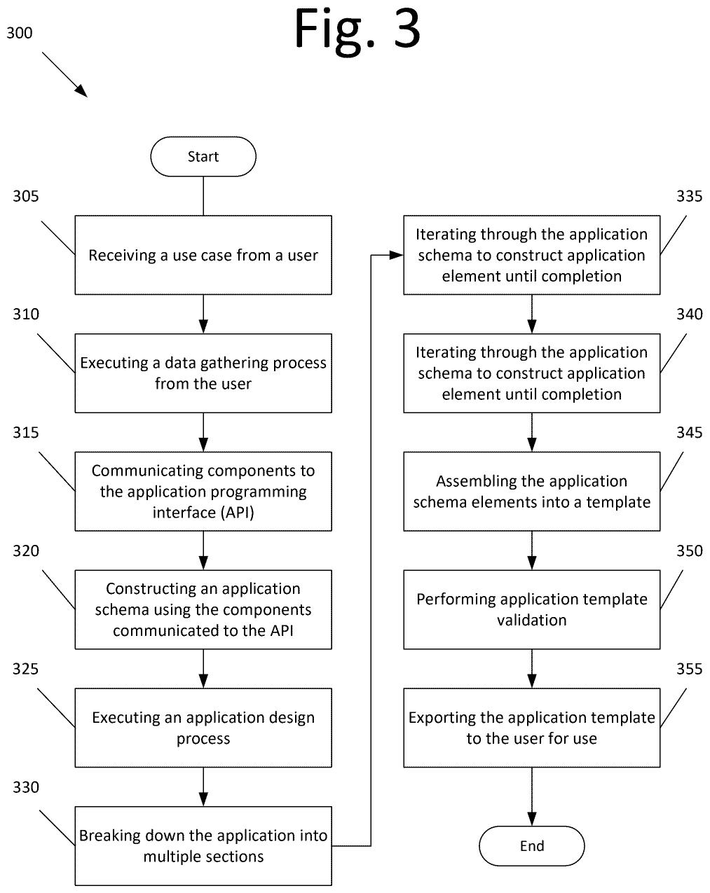

FIG. 3 is a diagram illustrating a method 300 for creating or generating the application template, a according to an embodiment of the present invention. Method 300 may begin at 305 with the system receiving a use case from the user (e.g., application developer). For example, the system may access a chat box in which there is a bot communicating with the user. In the chat box, the bot may request the user for what the user would like to do. In this example, the user may respond with a use case in which the user informs the bot that he or she would like to build an application for the use case.

Continuing with this example, the user sends the use case, where the user would like to build an application that connects his or her Shopify™ page to fetch orders from Shopify™ and lists one or more tickets in a ticket side panel based on a customer email identification. Let's say that the user is a Shopify™ seller, and there are orders from one or more customers. Further, let's say one of the customer placed a ticket, which relates to an order placed by the customer. In this example, when the user opens the ticket, the user may review all data associated with the ticket and the corresponding customer information. This method pertains to the integration of information from a third party application, such as Shopify™, into a single application.

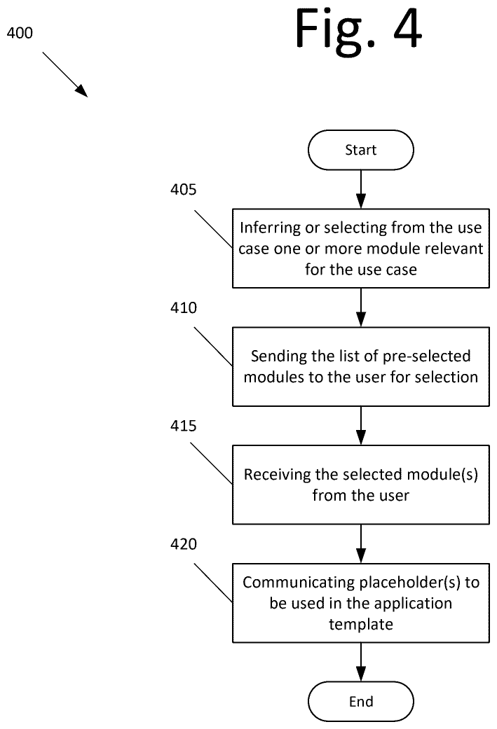

In order to understand what the application template is intended for, the system at 310 executes a series of steps to understand the use case, i.e., what does the application template means (i.e., whether there is an integration, is there a third party integration end point, UI components to show details of the ticket, etc.). FIG. 4 is a flow diagram illustrating a method 400 for performing prompt confirmation when receiving a use case from the user, according to an embodiment of the present invention. In some embodiments, method 400 may begin at 405 with the system inferring or selecting from the use case one or more modules that would appear to be relevant to the use case. It should be appreciated that the system or method has the knowledge of the products, and their associated modules offered by each business product. The API, events or even UI placeholders all are associated with this knowledge. This helps the application template generation by matching the input to the knowledge that exists based on the product(s) and their modules, including the user inputs, which also includes the UI design attributes that help in inferring and recommending the right modules and product associations for the application template as a metadata.

At 410, the system sends the user a list of pre-selected modules to select from, and at 415, the system receives one or more modules selected by the user. In short, this is a confirmation of the one or more modules selected by the user. At 420, the system may communicate via the chat box a plurality of placeholders to be used in the application template. This ensures where the application should be shown on the user's computing device. In some embodiments, a mockup of the application may be generated for the user's review.

Returning to FIG. 3, using the information received from the user, the system at 315 communicates use case keywords, integration endpoints, UI components, server side components, authentication model, etc., to an application programming interface (API) layer for developers. This communication helps the system access the ML models and/or LLMs when building the application template. At 320, the system may also begin constructing the application schema using the endpoint, authentication information, uniform resource locator (URL), and use case.

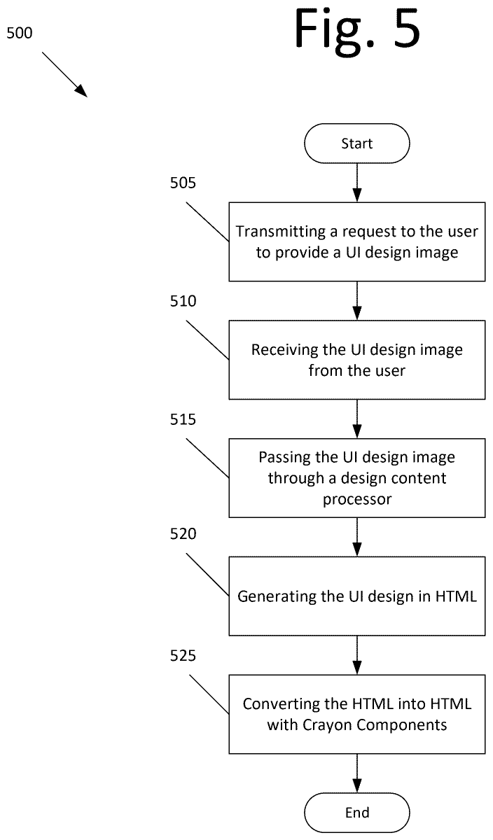

At 325, the system executes an application design process. FIG. 5 is a flow diagram illustrating a method 500 for executing an application design process, according to an embodiment of the present invention. In some embodiments, method 500 may begin at 505 with the system transmitting a request to the user to provide a UI design image. At 510, the system receives the UI design image from the user, and at 515, the system passes the UI design image through a design content processor. The design content processor is configured to understand the details present in the UI design. This includes, but is not limited to, the UI elements, components that help in capturing the user inputs (e.g., dropdowns, input text, button, selection, etc.). The design processor may involve a sequence of image recognition, and text recognition components that may solve for the content detection to arrive at the result, in some embodiments. At 515, the system generates the UI design in Hypertext Markup Language (HTML). At 520, the system converts the UI design into a HTML with Crayon™ components. This way, the application developed is easily migrated into Freshworks™ UI.

Returning to FIG. 3, method 300 continues at 330 with the system breaking down the application into multiple sections. By breaking down the application into multiple sections, the system may prompt the user to provide any missing attributes. For example, the system may ask the user if he or she wants the application to be shown in the Freshdesk™ ticket side panel. Another example, the system may ask if the user has a Shopify™ store URL.

At 335, the system iterates through the application schema to construct the application element and generates the application components in sequence until the iteration is complete. In this embodiment, the system performs a sequence of LLM calls and generations to process the content into different components such as HTTP component, third party authentication component, database element component, schedule component, webhook component, and product event component, to name a few. The application schema may determine the components that are used to develop the application. The system generates the application components in sequence until the iteration process is complete.

At 340, the system assembles the application schema elements into a template. At 345, the system performs an application template validation, i.e., is the application in a meaningful state; otherwise the application generation process continues. At 350, the system exports the application template to the user for use.

Stated another way, when an application is built, the application may contain multiple components. These components includes multiple endpoints, authentication process (which the other system may need), a URL component (to make the call). Using the Shopify™ example, the schema that gets constructed may include data such as third party endpoint identifying Shopify™, authentication token, URL identifying the Shopify™ store URL, use case for fetching orders based on the customer's email address.

Now, once the schema is made available, the system gathers application design and content information from the user. In this example, the system may request the user to provide or select a design scheme, and the system using the selected design scheme may begin generating the application code. The application code is Crayon™ HTML for the UI. This gives the user a basic start, and further allows the user to edit or change the application code.

By considering all the inputs (i.e., understanding the use case, confirming the requirements from the user, receiving the design scheme from the user, etc.), the schema of the application and the metadata of the application can be used to generate an application code. This allows the user to run the application code for debugging prior to launching the application.

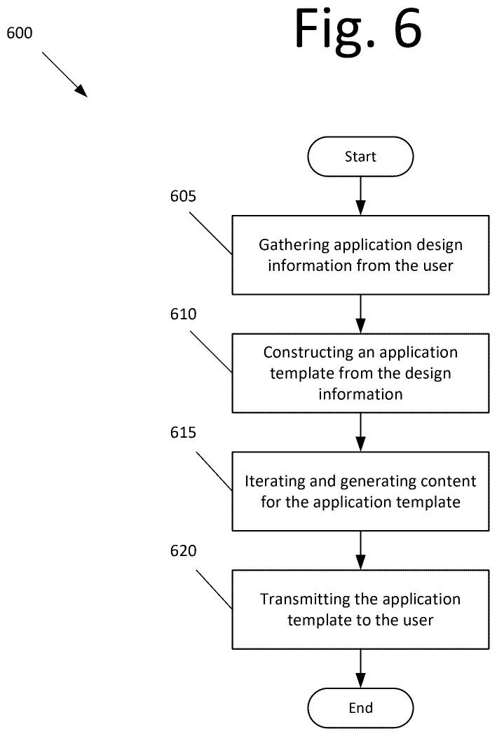

FIG. 6 is a flow diagram illustrating a method 600 for generating an application template based on a customer use case and design, according to an embodiment of the present invention. In some embodiment, method 600 begins at 605 with gathering application design information from the user, also known as application schema. At 610, a meaningful application template is constructed using the application design information. At 615, iterating and generating content for the application template, and at 620, transmitting the application template, including the generated content, for the user's review and integration. It should be appreciated that, in this embodiment, during each step, there is a communication between the user, the system, and the LLMs in order to develop the application template.

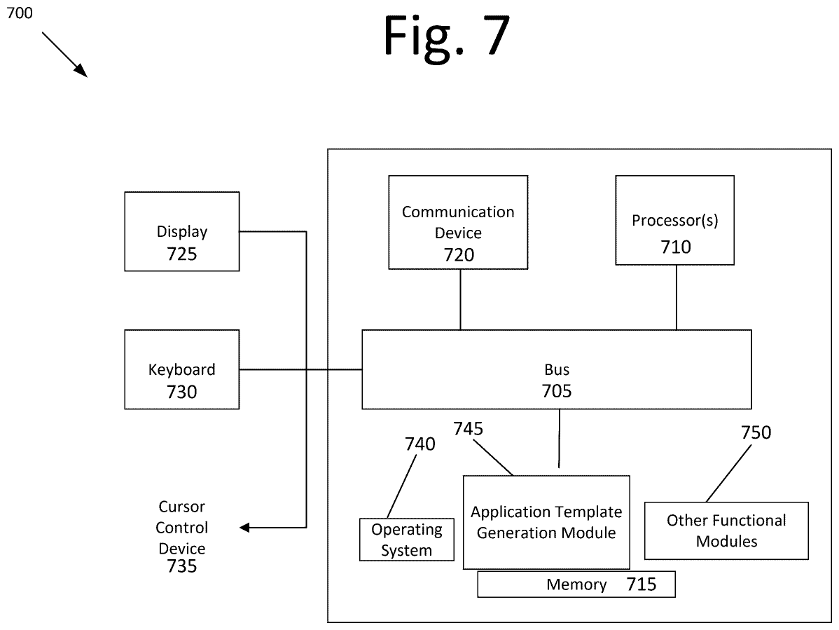

FIG. 7 is an architectural diagram illustrating a computing system 700 configured to generate and construction an application template including the components of the application template, according to an embodiment of the present invention. In some embodiments, computing system 700 may be one or more of the computing systems depicted and/or described herein. Computing system 700 includes a bus 705 or other communication mechanism for communicating information, and processor(s) 710 coupled to bus 705 for processing information. Processor(s) 710 may be any type of general or specific purpose processor, including a Central Processing Unit (CPU), an Application Specific Integrated Circuit (ASIC), a Field Programmable Gate Array (FPGA), a Graphics Processing Unit (GPU), multiple instances thereof, and/or any combination thereof. Processor(s) 710 may also have multiple processing cores, and at least some of the cores may be configured to perform specific functions. Multi-parallel processing may be used in some embodiments. In certain embodiments, at least one of processor(s) 710 may be a neuromorphic circuit that includes processing elements that mimic biological neurons. In some embodiments, neuromorphic circuits may not require the typical components of a Von Neumann computing architecture.

Computing system 700 further includes a memory 715 for storing information and instructions to be executed by processor(s) 710. Memory 715 can be comprised of any combination of random access memory (RAM), read-only memory (ROM), flash memory, cache, static storage such as a magnetic or optical disk, or any other types of non-transitory computer-readable media or combinations thereof. Non-transitory computer-readable media may be any available media that can be accessed by processor(s) 710 and may include volatile media, non-volatile media, or both. The media may also be removable, non-removable, or both. Computing system 700 includes a communication device 720, such as a transceiver, to provide access to a communications network via a wireless and/or wired connection. In some embodiments, communication device 720 may include one or more antennas that are singular, arrayed, phased, switched, beamforming, beamsteering, a combination thereof, and or any other antenna configuration without deviating from the scope of the invention.

Processor(s) 710 are further coupled via bus 705 to a display 725. Any suitable display device and haptic I/O may be used without deviating from the scope of the invention. A keyboard 730 and a cursor control device 735, such as a computer mouse, a touchpad, etc., are further coupled to bus 705 to enable a user to interface with computing system 700. However, in certain embodiments, a physical keyboard and mouse may not be present, and the user may interact with the device solely through display 725 and/or a touchpad (not shown). Any type and combination of input devices may be used as a matter of design choice. In certain embodiments, no physical input device and/or display is present. For instance, the user may interact with computing system 700 remotely via another computing system in communication therewith, or computing system 700 may operate autonomously.

Memory 715 stores software modules that provide functionality when executed by processor(s) 710. The modules include an operating system 740 for computing system 700. The modules further include an application template generation module 745 that is configured to perform all or part of the AI/ML processes described herein or derivatives thereof. Computing system 700 may include one or more additional functional modules 750 that include additional functionality.

One skilled in the art will appreciate that a “system” could be embodied as a server, an embedded computing system, a personal computer, a console, a smart watch, a personal digital assistant (PDA), a cell phone, a tablet computing device, a quantum computing system, or any other suitable computing device, or combination of devices without deviating from the scope of the invention. Presenting the above-described functions as being performed by a “system” is not intended to limit the scope of the present invention in any way, but is intended to provide one example of the many embodiments of the present invention. Indeed, methods, systems, and apparatuses disclosed herein may be implemented in localized and distributed forms consistent with computing technology, including cloud computing systems. The computing system could be part of or otherwise accessible by a local area network (LAN), a mobile communications network, a satellite communications network, the Internet, a public or private cloud, a hybrid cloud, a server farm, any combination thereof, etc. Any localized or distributed architecture may be used without deviating from the scope of the invention.

It should be noted that some of the system features described in this specification have been presented as modules, in order to more particularly emphasize their implementation independence. For example, a module may be implemented as a hardware circuit comprising custom very large scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may also be at least partially implemented in software for execution by various types of processors. An identified unit of executable code may, for instance, include one or more physical or logical blocks of computer instructions that may, for instance, be organized as an object, procedure, or function. Nevertheless, the executables of an identified module need not be physically located together, but may include disparate instructions stored in different locations that, when joined logically together, comprise the module and achieve the stated purpose for the module. Further, modules may be stored on a computer-readable medium, which may be, for instance, a hard disk drive, flash device, RAM, tape, and/or any other such non-transitory computer-readable medium used to store data without deviating from the scope of the invention.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

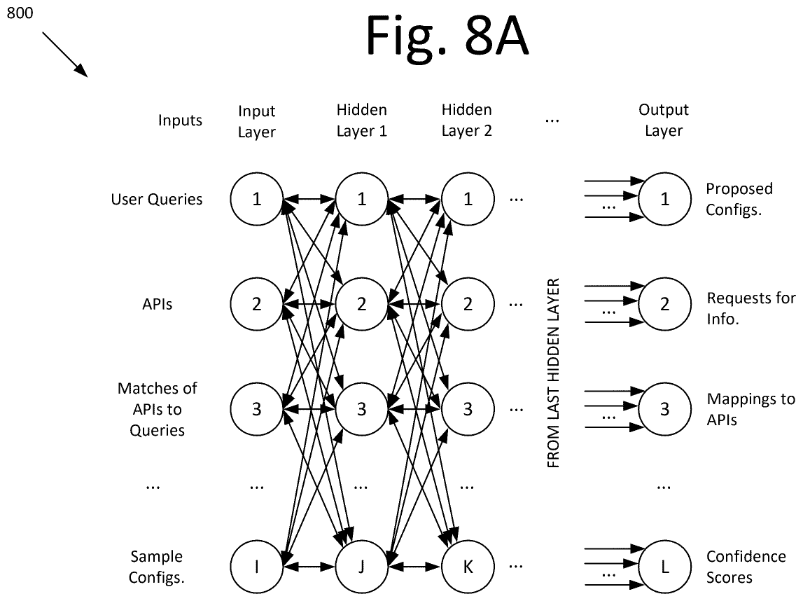

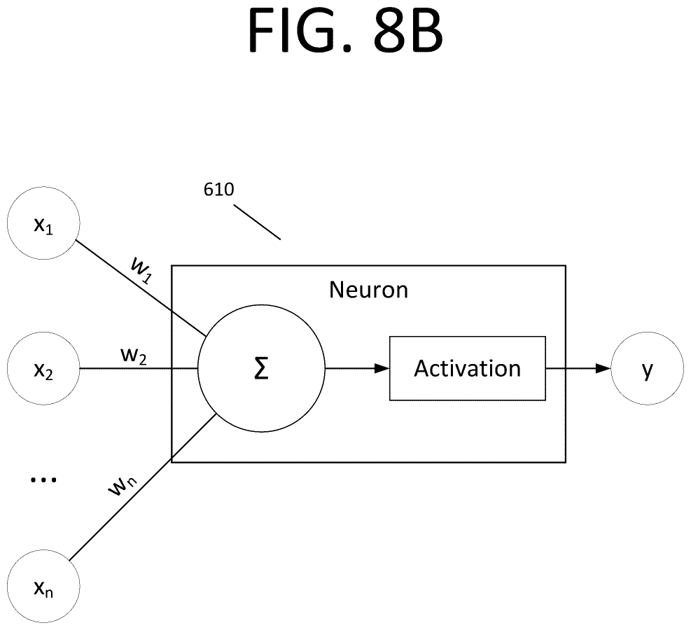

Various types of AI/ML models may be trained and deployed without deviating from the scope of the invention. For instance, FIG. 8A illustrates an example of a neural network 800 that has been trained to determine that a query may pertain to a dual-use application, according to an embodiment of the present invention. Neural network 800 includes a number of hidden layers. Both DLNNs and shallow learning neural networks (SLNNs) usually have multiple layers, although SLNNs may only have one or two layers in some cases, and normally fewer than DLNNs. Typically, the neural network architecture includes an input layer, multiple intermediate layers, and an output layer, as is the case in neural network 800.

A DLNN often has many layers (e.g., 10, 50, 200, etc.) and subsequent layers typically reuse features from previous layers to compute more complex, general functions. A SLNN, on the other hand, tends to have only a few layers and train relatively quickly since expert features are created from raw data samples in advance. However, feature extraction is laborious. DLNNs, on the other hand, usually do not require expert features, but tend to take longer to train and have more layers.

For both approaches, the layers are trained simultaneously on the training set, normally checking for overfitting on an isolated cross-validation set. Both techniques can yield excellent results, and there is considerable enthusiasm for both approaches. The optimal size, shape, and quantity of individual layers varies depending on the problem that is addressed by the respective neural network.

Returning to FIG. 8A, model state representations are provided as the input layer and fed as inputs to the J neurons of hidden layer 1. The model state information may include vector representations of the current model state, a state cloud, etc. While all of these inputs are fed to each neuron in this example, various architectures are possible that may be used individually or in combination including, but not limited to, feed forward networks, radial basis networks, deep feed forward networks, deep convolutional inverse graphics networks, convolutional neural networks, recurrent neural networks, artificial neural networks, long/short term memory networks, gated recurrent unit networks, generative adversarial networks, liquid state machines, auto encoders, variational auto encoders, denoising auto encoders, sparse auto encoders, extreme learning machines, echo state networks, Markov chains, Hopfield networks, Boltzmann machines, restricted Boltzmann machines, deep residual networks, Kohonen networks, deep belief networks, deep convolutional networks, support vector machines, neural Turing machines, or any other suitable type or combination of neural networks without deviating from the scope of the invention.

Hidden layer 2 receives inputs from hidden layer 1, hidden layer 3 receives inputs from hidden layer 2, and so on for all hidden layers until the last hidden layer provides its outputs as inputs for the output layer. In this embodiment, the predicted category of active capabilities, confidence score, active/present flag (e.g., 1 for dual-use and 0 for otherwise), and any other desired information are output from neural network 600. While multiple outputs are shown here as output, in some embodiments, only a single output is provided, such as the category.

It should be noted that numbers of neurons I, J, K, and L are not necessarily equal. Thus, any desired number of layers may be used for a given layer of neural network 800 without deviating from the scope of the invention. Indeed, in certain embodiments, the types of neurons in a given layer may not all be the same. Indeed, some embodiments may not use neural networks at all.

Neural network 800 is trained to assign confidence score(s)/pseudoprobabilities to appropriate outputs. In order to reduce predictions that are inaccurate, only those results with a confidence score that meets or exceeds a confidence threshold may be provided in some embodiments. For instance, if the confidence threshold is 80%, outputs with confidence scores exceeding this amount may be deemed to pertain to active capabilities and the rest may be ignored.

Neural networks are probabilistic constructs that typically have confidence score(s). This may be a score learned by the AI/ML model based on how often a similar input was correctly identified during training. Some common types of confidence scores include a decimal number between 0 and 1 (which can be interpreted as a confidence percentage as well), a number between negative co and positive ∞, a set of expressions (e.g., “low,” “medium,” and “high”), etc. Various post-processing calibration techniques may also be employed in an attempt to obtain a more accurate confidence score, such as temperature scaling, batch normalization, weight decay, negative log likelihood (NLL), etc.

“Neurons” in a neural network are implemented algorithmically as mathematical functions that are typically based on the functioning of a biological neuron. Neurons receive weighted input and have a summation and an activation function that governs whether they pass output to the next layer. This activation function may be a nonlinear thresholded activity function where nothing happens if the value is below a threshold, but then the function linearly responds above the threshold (i.e., a rectified linear unit (ReLU) nonlinearity). Summation functions and ReLU functions are used in deep learning since real neurons can have approximately similar activity functions. Via linear transforms, information can be subtracted, added, etc. In essence, neurons act as gating functions that pass output to the next layer as governed by their underlying mathematical function. In some embodiments, different functions may be used for at least some neurons.

An example of a neuron 810 is shown in FIG. 8B. Inputs x₁, x₂, . . . , xₙ from a preceding layer are assigned respective weights w₁, w₂, . . . , wₙ. Thus, the collective input from preceding neuron 1 is w₁x₁. These weighted inputs are used for the neuron's summation function modified by a bias, such as:

$${\sum }_{i = 1}^{m} ( {w}_{i} {x}_{i} ) + bias \qquad ( 1 )$$

This summation is compared against an activation function ƒ(x) to determine whether the neuron “fires”. For instance, ƒ(x) may be given by:

$$f ( x ) = \{ \begin{matrix}1 & if \sum wx + bias \geq 0 \\ 0 & if \sum wx + bias < 0\end{matrix} \qquad ( 2 )$$

The output y of neuron 610 may thus be given by:

$$y = f ( x ) {\sum }_{i = 1}^{m} ( {w}_{i} {x}_{i} ) + bias \qquad ( 3 )$$

In this case, neuron 810 is a single-layer perceptron. However, any suitable neuron type or combination of neuron types may be used without deviating from the scope of the invention. It should also be noted that the ranges of values of the weights and/or the output value(s) of the activation function may differ in some embodiments without deviating from the scope of the invention.

A goal, or “reward/objective/loss function,” is often employed. A reward function operationalizes the goal with both short-term and long-term rewards to guide the search of a state space (e.g., finding the most accurate answers to user inquiries based on associated metrics). During training, various labeled data is fed through neural network 800. Successful identifications strengthen weights for inputs to neurons, whereas unsuccessful identifications weaken them. A cost function may be used to punish predictions that are slightly wrong much less than predictions that are very wrong. If the performance of the AI/ML model is not improving after a certain number of training iterations, a data scientist may modify the reward function, provide corrections of incorrect predictions, etc.

Backpropagation is a technique for optimizing synaptic weights in a feedforward neural network. Backpropagation may be used to “pop the hood” on the hidden layers of the neural network to see how much of the loss every node is responsible for, and subsequently updating the weights in such a way that minimizes the loss by giving the nodes with higher error rates lower weights, and vice versa. In other words, backpropagation allows data scientists to efficiently implement gradient descent, and is provably equivalent to naïve approaches.

The backpropagation algorithm is mathematically founded in optimization theory. In supervised learning, training data with a known output is passed through the neural network and error is computed with a cost function from known target output, which gives the error for backpropagation. Error is computed at the output, and this error is transformed into corrections for network weights that will minimize the error.

In the case of supervised learning, an example of backpropagation is provided below. A column vector input x is processed through a series of N nonlinear activation functions ƒᵢ between each layer i=1, . . . , N of the network, with the output at a given layer first multiplied by a synaptic matrix Wᵢ, and with a bias vector bᵢ added. The network output o, given by

$$o = {f}_{N} ( {W}_{N} {f}_{N - 1} ( {W}_{N - 1} {f}_{N - 2} ( … {f}_{1} ( {W}_{1} x + {b}_{1} ) … ) + {b}_{N - 1} + {b}_{N} ) \qquad ( 4 )$$

In some embodiments, o is compared with a target output t, resulting in an error

$$E = \frac{1}{2} {‖ o - t ‖}^{2} ,$$

which is desired to be minimized.

Optimization in the form of a gradient descent procedure may be used to minimize the error by modifying the synaptic weights Wᵢ for each layer. The gradient descent procedure requires the computation of the output o given an input x corresponding to a known target output t, and producing an error o-t. This global error is then propagated backwards giving local errors for weight updates with computations similar to, but not exactly the same as, those used for forward propagation. In particular, the backpropagation step typically requires an activation function or the form

$${p}_{j} ( {n}_{j} ) = {f}_{j}^{′} ( {n}_{j} ) ,$$

where nⱼ is the network activity at layer j (i.e., nⱼ=Wⱼoⱼ₋₁+bⱼ) where oⱼ=ƒⱼ(nⱼ) and the apostrophe ′ denotes the derivative of the activity function ƒ.

The weight updates may be computed via the formulae:

$${d}_{j} = \{ \begin{matrix}( o - t ) ∘ {p}_{j} ( {n}_{j} ) , & j = N \\ {W}_{j + 1}^{T} {d}_{j + 1} ∘ {p}_{j} ( {n}_{j} ) , & j < N\end{matrix} \qquad ( 5 )$$

$$\frac{\partial E}{\partial {W}_{j + 1}} = {{d}_{j + 1} ( {o}_{j} )}^{T} \qquad ( 6 )$$

$$\frac{\partial E}{\partial {b}_{j + 1}} = {d}_{j + 1} \qquad ( 7 )$$

$${W}_{j}^{new} = {W}_{j}^{old} - η \frac{\partial E}{\partial {W}_{j}} \qquad ( 8 )$$

$${b}_{j}^{new} = {b}_{j}^{old} - η \frac{\partial E}{\partial {b}_{j}} \qquad ( 9 )$$

where ∘ denotes a Hadamard product (i.e., the element-wise product of two vectors), ^{T} denotes the matrix transpose, and oⱼ denotes ƒⱼ(Wⱼoⱼ₋₁+bⱼ), with o₀=x. Here, the learning rate η is chosen with respect to machine learning considerations. Note that the synapses W and b can be combined into one large synaptic matrix, where it is assumed that the input vector has appended ones, and extra columns representing the b synapses are subsumed to W.

The AI/ML model may be trained over multiple epochs until it reaches a good level of accuracy (e.g., 97% or better using an F2 or F4 threshold for detection and approximately 2,000 epochs). This accuracy level may be determined in some embodiments using an F1 score, an F2 score, an F4 score, or any other suitable technique without deviating from the scope of the invention. Once trained on the training data, the AI/ML model may be tested on a set of evaluation data that the AI/ML model has not encountered before. This helps to ensure that the AI/ML model is not “over fit” such that it performs well on the training data, but does not perform well on other data.

In some embodiments, it may not be known what accuracy level is possible for the AI/ML model to achieve. Accordingly, if the accuracy of the AI/ML model is starting to drop when analyzing the evaluation data (i.e., the model is performing well on the training data, but is starting to perform less well on the evaluation data), the AI/ML model may go through more epochs of training on the training data (and/or new training data). In some embodiments, the AI/ML model is only deployed if the accuracy reaches a certain level or if the accuracy of the trained AI/ML model is superior to an existing deployed AI/ML model. In certain embodiments, a collection of trained AI/ML models may be used to accomplish a task. For example, one model may be trained to recognize images, another may recognize text, yet another may recognize semantic and/or ontological associations, etc.

Some embodiments may use transformer networks such as BERT. Such transformer networks learn associations of words and phrases that have both high scores and low scores. This trains the AI/ML model to determine what is close to the input and what is not, respectively. Rather than just using pairs of words/phrases, transformer networks may use the field length and field type, as well.

NLP models such as word2vec, BERT, GPT-3, ChatGPT, other LLMs, etc. may be used in some embodiments to facilitate semantic understanding and provide more accurate and human-like answers, per the above. Other techniques, such as clustering algorithms, may be used to find similarities between groups of elements. Clustering algorithms may include, but are not limited to, density-based algorithms, distribution-based algorithms, centroid-based algorithms, hierarchy-based algorithms. K-means clustering algorithms, the DBSCAN clustering algorithm, the Gaussian mixture model (GMM) algorithms, the balance iterative reducing and clustering using hierarchies (BIRCH) algorithm, etc. Such techniques may also assist with categorization.

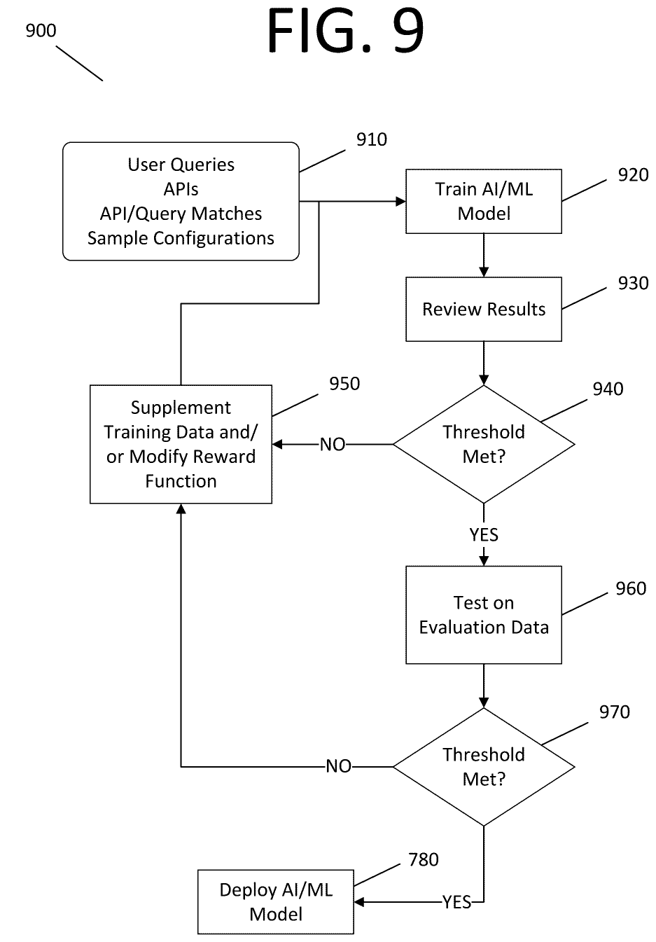

FIG. 9 is a flowchart illustrating a process 900 for training AI/ML model(s), according to an embodiment of the present invention. In some embodiments, the AI/ML model(s) may be generative AI models, per the above. The neural network architecture of AI/ML models typically include multiple layers of neurons, including input, output, and hidden layers. See FIGS. 8A and 8B, for example. The hidden layers in between process the input data and generate intermediate representations of the input that are used to generate the output. These hidden layers can include various types of neurons, such as convolutional neurons, recurrent neurons, and/or transformer neurons.

The training process of the capability detection model begins with providing model state representations, whether labeled or unlabeled, at 910. It should be noted that capability detection may function without learned parameters and training in some embodiments, such as using kNN. The AI/ML model is then trained over multiple epochs at 920 and results are reviewed at 930. While various types of training regimes may be used, LLMs and other generative AI models are typically trained using a process called “supervised learning”, which is also discussed above. Supervised learning involves providing the model with a large dataset, which the model uses to learn the relationships between the inputs and outputs. During the training process, the model adjusts the weights and biases of the neurons in the neural network to minimize the difference between the predicted outputs and the actual outputs in the training dataset.

One aspect of the models in some embodiments is the use of transfer learning. For instance, transfer learning may take advantage of a pretrained model, such as ChatGPT, which is fine-tuned on a specific task or domain in step 920. This allows the model to leverage the knowledge already learned from the pretraining phase and adapt it to a specific application via the training phase of step 920.

The pretraining phase typically involves training the original model on an initial set of training data that may be more general, although it should be noted that the P7/F7 distinction is getting blurrier. During this phase, the original model learns relationships in the data. In the fine-tuning phase (e.g., performed during step 920 in addition to or in lieu of the initial training phase in some embodiments if a pretrained original model is used as the initial basis for the final model), the pretrained original model is adapted to a specific task or domain by training the model on a smaller dataset that is specific to the task. For instance, in some embodiments, the final model may be focused on certain types(s) of data sources. This may help the model to more accurately identify data elements therein than a generative AI model that is pretrained alone. Fine-tuning allows the final model to learn the nuances of the source, such as the specific vocabulary and syntax, certain graphical characteristics, certain data formats, etc., without requiring as much data as would be necessary to train the final model from scratch. By leveraging the knowledge learned in the pretraining phase, the fine-tuned, final model can achieve state-of-the-art performance on specific tasks with relatively little additional training data.

If the AI/ML model fails to meet a desired confidence threshold at 940, the training data is supplemented and/or the reward function is modified to help the AI/ML model achieve its objectives better at 950 and the process returns to step 920. If the AI/ML model meets the confidence threshold at 940, the AI/ML model is tested on evaluation data at 960 to ensure that the AI/ML model generalizes well and that the AI/ML model is not over fit with respect to the training data. The evaluation data includes information that the AI/ML model has not processed before. If the confidence threshold is met at 970 for the evaluation data, the AI/ML model is deployed at 780. If not, the process returns to step 950 and the AI/ML model is trained further.

The process steps performed in FIGS. 2-6 and 8-10 may be performed by a computer program, encoding instructions for the processor(s) to perform at least part of the process(es) described in FIGS. 2-6 and 8-10, in accordance with embodiments of the present invention. The computer program may be embodied on a non-transitory computer-readable medium. The computer-readable medium may be, but is not limited to, a hard disk drive, a flash device, RAM, a tape, and/or any other such medium or combination of media used to store data. The computer program may include encoded instructions for controlling processor(s) of a computing system (e.g., processor(s) 710 of computing system 700 of FIG. 7) to implement all or part of the process steps described in FIGS. 2-6 and 8-10, which may also be stored on the computer-readable medium.

The computer program can be implemented in hardware, software, or a hybrid implementation. The computer program can be composed of modules that are in operative communication with one another, and which are designed to pass information or instructions to display. The computer program can be configured to operate on a general purpose computer, an ASIC, or any other suitable device.

It will be readily understood that the components of various embodiments of the present invention, as generally described and illustrated in the figures herein, may be arranged and designed in a wide variety of different configurations. Thus, the detailed description of the embodiments of the present invention, as represented in the attached figures, is not intended to limit the scope of the invention as claimed, but is merely representative of selected embodiments of the invention.

The features, structures, or characteristics of the invention described throughout this specification may be combined in any suitable manner in one or more embodiments. For example, reference throughout this specification to “certain embodiments,” “some embodiments,” or similar language means that a particular feature, structure, or characteristic described in connection with the embodiment is included in at least one embodiment of the present invention. Thus, appearances of the phrases “in certain embodiments,” “in some embodiment,” “in other embodiments,” or similar language throughout this specification do not necessarily all refer to the same group of embodiments and the described features, structures, or characteristics may be combined in any suitable manner in one or more embodiments.

It should be noted that reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

1. One or more non-transitory computer-readable media storing one or more computer programs for generating an application template, the one or more computer programs configured to cause at least one processor to perform:
receiving a use case from a user;
analyzing the use case for missing attributes or ambiguities;
communicating with the user with a request, wherein the request is a notification for the user to provide the missing attributes or ambiguities;
receiving a response from the user; and
generating an application template with code across a plurality of files, application manifest, and generated meta data, wherein the application template provides the user closer to a working application.

2. The one or more non-transitory computer-readable media of claim 1, wherein the one or more computer programs are configured to cause at least one processor to perform:
accessing a chat box in which a bot is communicating with the user; and
sending the request to the user via the chat box for the use case.

3. The one or more non-transitory computer-readable media of claim 1, wherein the one or more computer programs are configured to cause at least one processor to perform:
upon receiving the request, execute a series of steps to understand parameters of the use case.

4. The one or more non-transitory computer-readable media of claim 3, wherein the one or more computer programs are configured to cause at least one processor to perform:
identifying from the use case one or more modules that is relevant to the use case;
sending the user a list of the identified one or more modules to select from;
receiving one or more selected modules selected by the user, confirming the one or more selected modules by the user; and
communicating via the chat box a plurality of placeholders to be used in the application template.

5. The one or more non-transitory computer-readable media of claim 3, wherein the one or more computer programs are configured to cause at least one processor to perform:
using one or more selected modules received from the user to communicate use case keywords, integration endpoints, user interface (UI) components, server side components, and/or authentication model, to an application programming interface (API) layer for developers.

6. The one or more non-transitory computer-readable media of claim 5, wherein the one or more computer programs are configured to cause at least one processor to perform:
executing an application design process.

7. The one or more non-transitory computer-readable media of claim 6, wherein the one or more computer programs are configured to cause at least one processor to perform:
transmitting a request to the user to provide a UI design image;
receiving the UI design image from the user;
passing the UI design image through a design content processor, wherein the design content processor is configured to understand the details present in the UI design;
generating the UI design in Hypertext Markup Language (HTML); and
converting the UI design into a HTML with Crayon™ components such that the application developed is easily migrated into Freshworks™ UI.

8. The one or more non-transitory computer-readable media of claim 6, wherein the one or more computer programs are configured to cause at least one processor to perform:
breaking down the application into multiple sections, wherein the breaking down comprises
prompting the user to provide one or more missing attributes.

9. The one or more non-transitory computer-readable media of claim 8, wherein the one or more computer programs are configured to cause at least one processor to perform:
iterating through an application schema to construct one or more application elements; and
generating one or more application components in sequence until the iteration is complete.

10. The one or more non-transitory computer-readable media of claim 9, wherein the one or more computer programs are configured to cause at least one processor to perform:
assembling one or more application schema elements into a template;
performing an application template validation; and
exporting the application template to the user for use.

11. A computer-implemented method for generating an application template, comprising:
receiving a use case from a user;
analyzing the use case for missing attributes or ambiguities;
communicating with the user with a request, wherein the request is a notification for the user to provide the missing attributes or ambiguities;
receiving a response from the user; and
generating an application template with code across a plurality of files, application manifest, and generated meta data, wherein the application template provides the user closer to a working application.

12. The computer-implemented method of claim 11, further comprising:
accessing a chat box in which a bot is communicating with the user; and
sending the request to the user via the chat box for the use case.

13. The computer-implemented method of claim 11, further comprising:
upon receiving the request, execute a series of steps to understand parameters of the use case.

14. The computer-implemented method of claim 13, further comprising:
identifying from the use case one or more modules that is relevant to the use case;
sending the user a list of the identified one or more modules to select from;
receiving one or more selected modules selected by the user, confirming the one or more selected modules by the user; and
communicating via the chat box a plurality of placeholders to be used in the application template.

15. The computer-implemented method of claim 13, further comprising:
using one or more selected modules received from the user to communicate use case keywords, integration endpoints, user interface (UI) components, server side components, and/or authentication model, to an application programming interface (API) layer for developers.

16. The computer-implemented method of claim 15, further comprising:
executing an application design process.

17. The computer-implemented method of claim 16, further comprising:
transmitting a request to the user to provide a UI design image;
receiving the UI design image from the user;
passing the UI design image through a design content processor, wherein the design content processor is configured to understand the details present in the UI design;
generating the UI design in Hypertext Markup Language (HTML); and
converting the UI design into a HTML with Crayon™ components such that the application developed is easily migrated into Freshworks™ UI.

18. The computer-implemented method of claim 16, further comprising:
breaking down the application into multiple sections, wherein the breaking down comprises
prompting the user to provide one or more missing attributes.

19. The computer-implemented method of claim 18, further comprising:
iterating through an application schema to construct one or more application elements; and
generating one or more application components in sequence until the iteration is complete.

20. The computer-implemented method of claim 19, further comprising:
assembling one or more application schema elements into a template;
performing an application template validation; and
exporting the application template to the user for use.
